(19) United States
(12) Patent Application Publication
(10) Pub. No.: US 2026/0292504 A1
(43) Pub. Date: Sep. 24, 2026

(54) AUTHORIZATION OF EDGE ENABLER CLIENT (EEC) CONTEXT TRANSFER

(71) Applicant: Interdigital Patent Holdings, Inc., Wilmington, DE (US)

(72) Inventors: Zhibi WANG, Woodridge, IL (US); Michel ROY, Candiac (CA); Michael STARSINIC, Newtown, PA (US); Kevin DI LALLO, Laval (CA); Taimoor ABBAS, Sainte-Julie (CA)

(73) Assignee: Interdigital Patent Holdings, Inc., Wilmington, DE (US)

(21) Appl. No.: 19/473,368

(22) PCT Filed: Apr. 5, 2024
(86) PCT No.: PCT/US2024/023377

§ 371 Date: Oct. 7, 2025

Related U.S. Application Data
(60) Provisional application No. 63/458,015, filed on Apr. 7, 2023.

(51) Int. Cl. H04W 12/084

(52) U.S. Cl. CPC H04W 12/084

(57) ABSTRACT

Methods, devices, and systems for edge enabler client (EEC) context transfer security and authorization. In some embodiments, the EEC may authorize and/or consent to a transfer of EEC context information from a source edge enabler server (S-EES) to a target edge enabler server (T-EES). In various embodiments, the EEC context may be relocated from the S-EES to the T-EES via a push (S-EES initiated) or pull (T-EES initiated) fashion. In some application context relocation (ACR) procedures, the EEC context may be transferred even when communication between the EEC and S-EES is not possible or not reliable. Accordingly, in some embodiments, EEC context transfer mechanisms may allow the EEC to authorize the context transfer even when communication between the EEC and T-EES is not possible or not reliable during the context transfer.

### RELATED APPLICATIONS

The present application claims the benefit of and priority to U.S. Provisional Patent Application No. 63/458,015, entitled “Authorization of Edge Enabler Client (EEC) Context Transfer,” filed Apr. 7, 2023, the entirety of which is incorporated by reference herein.

### BACKGROUND

Edge Computing enables services to be hosted close to user equipment or other client devices, and can provide low latency and high-bandwidth service while reducing traffic across the network backbone. Such services may provide myriad capabilities, including virtual and augmented reality, real-time video gaming, teleconferencing, autonomous driving, and artificial intelligence-enhanced applications.

In many embodiments, an edge enabler client (EEC) may be executed by a client device, such as a wireless transmit receive unit (WTRU), user equipment (UE), or other computing device, to communicate with edge configuration servers (ECS) and/or edge enabler servers (EES). The EES may provide EEC context information, such as WTRU or UE identity information, location information, application client (AC) profiles, service session context information, and/or other information. The context information may be sent from a source EES (S-EES) to a target EES (T-EES) during application context relocation (ACR) procedures. However, this information may be sensitive and exfiltration or interception by malicious actors may result in security threats, impaired functionality, or additional vectors for attack.

### SUMMARY

Described herein are embodiments of systems and methods for EEC context transfer security and authorization. In some embodiments, the EEC may authorize and/or consent to a transfer of EEC context information from a S-EES to the T-EES. Authorization may have different levels of granularity, depending on embodiment, including authorizing EEC context transfer to a particular T-EES, authorizing a specific transfer operation, authorizing specific information to be transferred, etc. In some embodiments, the EEC may authorization a specific transfer operation as part of a specific ACR procedure. For example, in some such embodiments, each EEC context transfer from a S-EES to a T-EES for an EEC may be separately or individually authorized by that EEC for each ACR procedure, even if the EEC is not involved in the selection of the T-EES.

In various embodiments, the EEC context may be relocated from the S-EES to the T-EES via a push (S-EES initiated) or pull (T-EES initiated) fashion. In some ACR procedures, the EEC context may be transferred even when communication between the EEC and S-EES is not possible or not reliable. Accordingly, in some embodiments, EEC context transfer mechanisms may allow the EEC to authorize the context transfer even when communication between the EEC and T-EES is not possible or not reliable during the context transfer.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment; and

FIG. 1D is a system diagram illustrating a further example RAN and a further example CN that may be used within the communications system illustrated in FIG. 1A according to an embodiment;

FIG. 2 is a block diagram of an embodiment of a system for enabling edge applications;

FIG. 3 is a flow chart of an embodiment of a method for application context relocation;

FIG. 4 is a flow chart of an embodiment of a method for EEC authorization of EEC context transfer with EEC initiation, and EEC context pulled from the S-EES to the T-EES;

FIG. 5 is a flow chart of an embodiment of a method for EEC authorization of EEC context transfer without EEC initiation, and EEC context pushed from the S-EES to the T-EES;

FIG. 6 is a flow chart of an embodiment of a method for EEC authorization of EEC context transfer with EEC initiation, and EEC context pushed from the S-EES to the T-EES;

FIGS. 7A and 7B are a flow chart of an embodiment of a method for EEC authorization of EEC context transfer; and

FIG. 8 is a flow chart of an embodiment of a method for EEC authorization of EEC context transfer.

### DETAILED DESCRIPTION

Edge Computing enables services to be hosted close to user equipment or other client devices, and can provide low latency and high-bandwidth service while reducing traffic across the network backbone. Such services may provide myriad capabilities, including virtual and augmented reality, real-time video gaming, teleconferencing, autonomous driving, and artificial intelligence-enhanced applications.

In many embodiments, an edge enabler client (EEC) may be executed by a client device, such as a wireless transmit receive unit (WTRU), user equipment (UE), or other computing device, to communicate with edge configuration servers (ECS) and/or edge enabler servers (EES). The EES may provide EEC context information, such as WTRU or UE identity information, location information, application client (AC) profiles, service session context information, and/or other information. The context information may be sent from a source EES (S-EES) to a target EES (T-EES) during application context relation (ACR) procedures. However, this information may be sensitive and exfiltration or interception by malicious actors may result in security threats, impaired functionality, or additional vectors for attack.

Described herein are embodiments of systems and methods for EEC context transfer security and authorization. In some embodiments, the EEC may authorize and/or consent to a transfer of EEC context information from a S-EES to the T-EES. Authorization may have different levels of granularity, depending on embodiment, including authorizing EEC context transfer to a particular T-EES, authorizing a specific transfer operation, authorizing specific information to be transferred, etc. In some embodiments, the EEC may authorization a specific transfer operation as part of a specific ACR procedure. For example, in some such embodiments, each EEC context transfer from a S-EES to a T-EES for an EEC may be separately or individually authorized by that EEC for each ACR procedure, even if the EEC is not involved in the selection of the T-EES.

In a first aspect, the present disclosure is directed to embodiments of methods and systems for EEC Authorization of EEC Context transfer in a scenario where an ACR procedure is initiated by the EEC and EEC Context is pulled from the S-EES to the T-EES. In these embodiments, the EEC may obtain a token before any entity in the edge enablement layer (EEL) determines to initiate an ACR procedure. The EEC may negotiate with a Token Server to place limits on which entities can use the token and/or other limitations (e.g. time, date, specific applications, etc.). The EEC may provide the token to the S-EES. The S-EES may subsequently use the token when authorizing a request from the T-EES to retrieve the EEC's context. In some such embodiments, the EEC may be able to exercise a degree of control over where its context can be transferred, even if the S-EES is not able to communicate with the EEC at the time when the context transfer needs to take place.

In another aspect, the present disclosure is directed to embodiments of methods and systems for EEC Authorization of EEC Context transfer in a scenario where an ACR procedure is not initiated by the EEC and the EEC Context be pushed from the S-EES to the T-EES. In these embodiments, the EEC may obtain a token before any entity in the EEL determines to initiate an ACR procedure. The EEC may negotiate with a Token Server to place limits on which entities can use the token and/or other limitations (e.g. time, date, specific applications, etc.). The EEC may provide the token to the S-EES. The S-EES may subsequently use the token when transferring context to the T-EES. In some such embodiments, the EEC may be able to exercise a degree of control over where its context can be transferred, even if the S-EES is not able to communicate with the EEC at the time when the context transfer needs to take place.

In still another aspect, the present disclosure is directed to embodiments of methods and systems for EEC Authorization of EEC Context transfer in a scenario where an ACR procedure is initiated by the EEC and the EEC Context is pushed from the S-EES to the T-EES. In these embodiments, the EEC determines to perform an ACR procedure, obtains a token, and sends the token to the S-EES. The S-EES may subsequently provide the token to the T-EES so that the T-EES can verify that it is permitted to receive the EEC's context.

Various embodiments of these systems and methods use tokens to authorize a transfer for EEC context from a S-EES to a T-EES. The token may be an OAuth 2.0 Access Token, in some embodiments, and may be generated by a server (e.g. token server, edge configuration server (ECS) or another device. In some embodiments, the server that generates the token may be referred to as an authorization server. In various embodiments, the EEC may authorize the transfer of context information from a S-EES to a T-EES. Authorization may be a type of consent, and accordingly, in such embodiments, the EEC may give consent to the transfer of context information from a S-EES to a T-EES. The EEC may operate on behalf of or be operated by a user, and accordingly, this type of consent may be called user consent. Context information transferred from a first EES to a second EES may include information related to one or more application layer sessions.

For reference, various abbreviations and acronyms are used herein, e.g., as follows:
3GPP Third Generation Partnership Project
5 5th Generation
AC Application Client
ACR Application Context Relocation
ACT Application Context Transfer
DNN Data Network Name
EAS Edge Application Server
ECS Edge Configuration Server
ECSP Edge Computing Service Provider
EDN Edge Data Network
EEC Edge Enabler Client
EEL Edge Enablement Layer
EES Edge Enabler Server
FQDN Fully Qualified Domain Name
KI Key Issue
KPI Key Performance Indicator
MNO Mobile Network Operator
NMC Notification Management Client
NMS Notification Management Server
QoS Quality of Service
SCP Service Continuity Planning
S-EAS Source Edge Application Server
S-EES Source Edge Enabler Server
TR Technical Report
TS Technical Specification
T-EAS Target Edge Application Server
T-EES Target Edge Enabler Server
UID User Identifier
URI Universal Resource Identifier
UE User Equipment
WLAN Wireless Local Area Networks and related technologies (IEEE 802.1 domain)
WTRU Wireless Transmit Receive Unit

Prior to discussing embodiments and embodiments of the systems and methods discussed herein, it may be helpful to briefly discuss embodiments of communications systems and devices which may be used with these systems and methods.

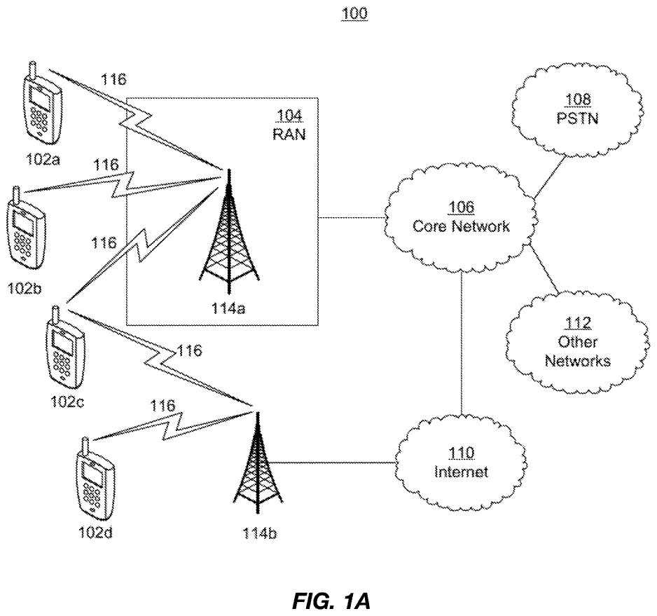

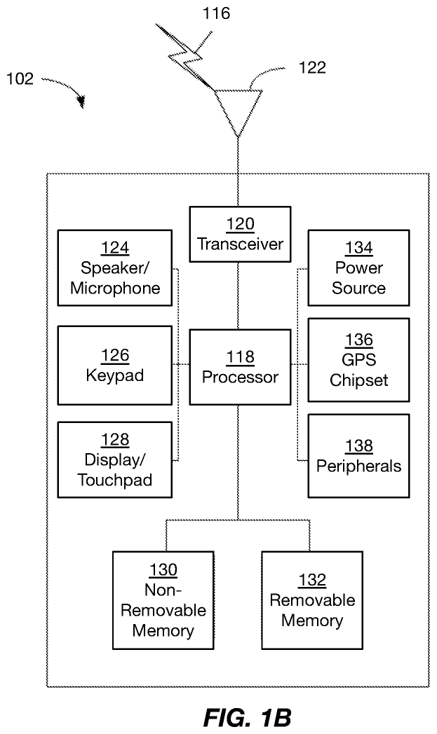

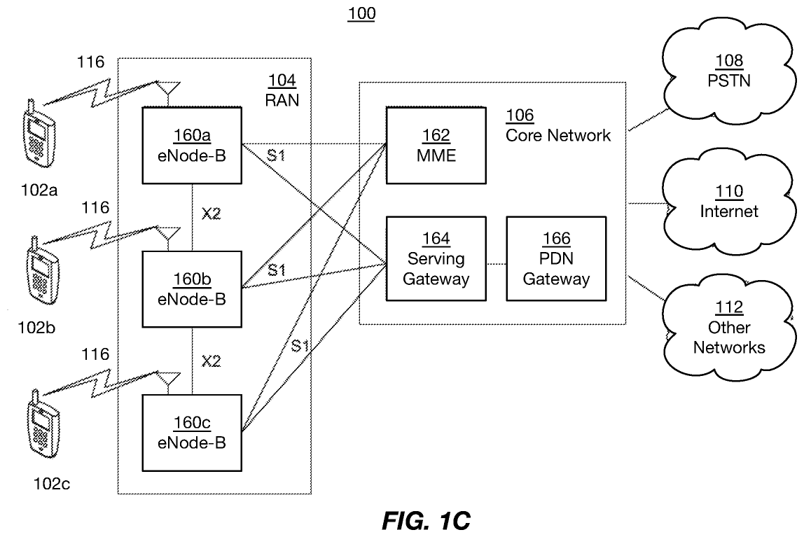

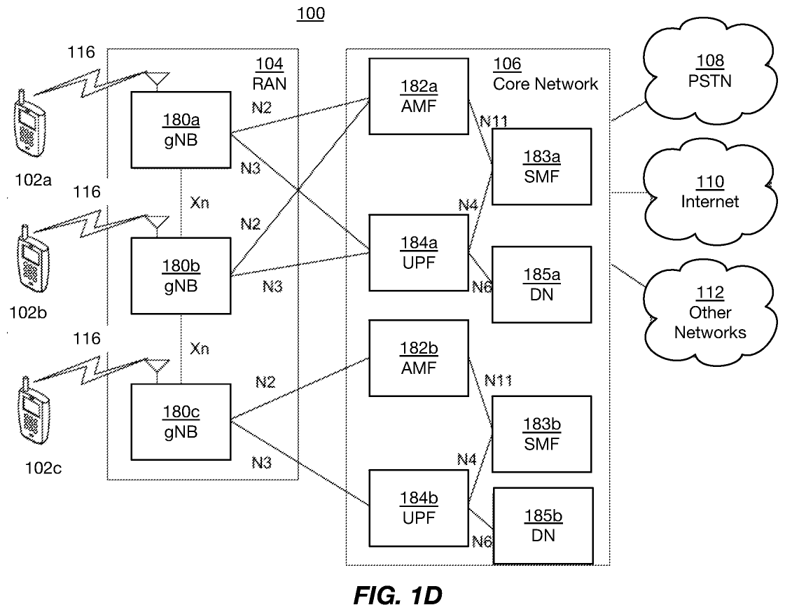

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 3X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QOS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

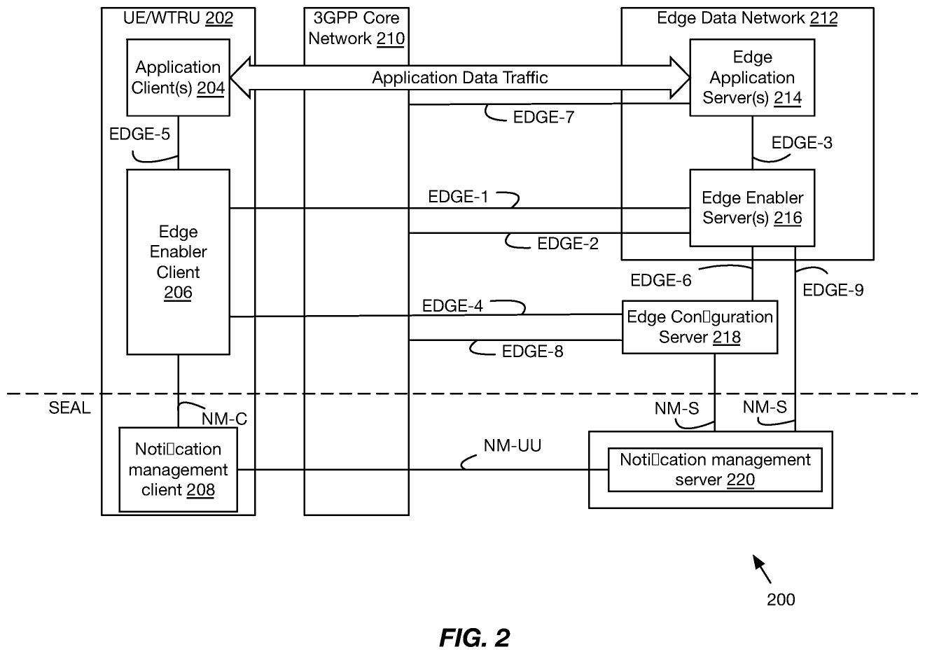

FIG. 2 is a block diagram of an embodiment of a system 200 for enabling edge applications. In brief overview, the system may comprise a UE or WTRU 202 or other device (referred to variously as a UE, a WTRU, a mobile device, a smart phone, a mobile computing device, a remote device, a wearable device, or by any other similar terms) in communication via a network 210 (e.g. a 3GPP Core Network, or any other type and form of network) with an edge data network 212, an edge configuration server 218, and/or a notification management server 220.

As shown, in some implementations, a WTRU 202 may comprise or execute one or more application clients 204. In some embodiments, an Application Client (AC) 204 is a user application residing on a UE that communicates with an edge application server (EAS) 214. A UE or WTRU 202 may use several ACs 204 concurrently. For example, a WTRU 202 may comprise one or more processors executing one or more ACs 204 stored in memory of the WTRU 202. For example, in some implementations, ACs 204 may comprise web browsing applications, social media applications, video game applications, productivity applications, remote desktop applications, or any other type and form of applications. In many implementations, an AC 204 may comprise a web application or application executed within a web browser or similar local application, in communication with an application server such as an EAS 214.

In some embodiments, an Edge Application Server (EAS) 214 is an application server resident in an edge data network (EDN) 212. The EAS may comprise hardware, software, or a combination of hardware and software. For example, in some implementations, the EAS may comprise one or more software servers executing on generic hardware (e.g. a cloud server, cluster, or virtual machine farm) located at the edge data network 212 and providing a service to the AC 202. For example, EAS 214 may comprise a web server providing a web application (e.g. a mail application, productivity application, etc.) to one or more WTRUs 202 and ACs 204.

In some implementations, a WTRU may be relocated geographically and/or logically. For example, as a WTRU 202 moves within an area, it may be geographically closer to various EASs 214. Physically nearby EASs 214 may have lower latency connections to the WTRU, and accordingly, it may be desirable to switch the WTRU and AC 204 from a first EAS providing an application (referred to as a source EAS or S-EAS) to a second EAS that may provide the same application (referred to as a target EAS or T-EAS). In some implementations, the second EAS or target EAS may not necessarily be geographically closer than the S-EAS, but may be logically closer-that is, network speeds, bandwidth, or congestion may be such that a connection from the WTRU 202 to the T-EAS is faster or has lower latency than a connection to the S-EAS, regardless of physical proximity. Accordingly, in various implementations, it may be desirable to switch the WTRU from services provided by the S-EAS to services provided by the T-EAS based on location, latency, throughput, congestion, or any other physical characteristics and/or network characteristics. Such switching may be referred to as a relocation, although as discussed above in some implementations, the WTRU may not physically change location. As discussed in more detail below, relocating the WTRU from a S-EAS to a T-EAS may include transferring configuration and/or state information (referred to generally as a context) from the S-EAS to the T-EAS. For example, if the S-EAS is providing a stateful web application to the AC 204, switching the AC to a T-EAS without transferring the context may result in the web application crashing or losing its state and being unable to fulfill requests until reloaded. This may impair functionality, result in loss of data, etc. Instead, implementations of the systems and methods discussed herein may provide for seamless context transfer between S-EAS and T-EAS, allowing for continued use by relocated ACs.

In the context of a mobility/relocation use case, the Source-EAS (S-EAS) may be an instance of an EAS in an initial location serving the AC before mobility/relocation happens, and the Target-EAS (T-EAS) may be an instance of an EAS in a destination location serving the AC after mobility/relocation has happened. There can be multiple EAS instances 214 per EDN 212. Each EDN 212 may contain a different set of EAS instances 214 of different types (e.g., different EASID); an EAS 214 may serve one or more AC instances 204 that may reside on different UEs 202.

In some embodiments, an Edge Enabler Client (EEC) 206 provides edge support to the AC 202 instances on the UE/WTRU 202. There can be one or more EEC 206 per UE 202. In some embodiments, each AC 204 uses only one EEC 206. For example, the EEC 206 may comprise a plug-in or sub-routine of the AC 204, or may be executed as a handler dedicated to an AC 204 and configured to hook or intercept calls to and from the AC 204. Accordingly, in various implementations, EEC 206 may comprise an application, service, server, daemon, routine, or other executable logic for communicating with Edge Enabler Server(s) 216 and Edge Configuration Server(s) 218 on behalf of ACs 204, including for managing context switching or relocation.

In some embodiments, an Edge Enabler Server (EES) 216 provides supporting functions needed by EAS 214 and EEC 206. An EES 216 may comprise an application, server, service, daemon, routine, or other executable logic for transferring states and/or configuration information or other context information between EASs 214 on behalf of ACs 204 and in communication with EECs 206. EES 216 may be executed by one or more physical computing devices (e.g. servers, workstations, etc.) or one or more virtual computing devices executed by one or more physical computing devices (e.g. as a cloud service, virtual server farm, etc.). EES 216 may be executed by the same device as an EAS 214 or may be executed by a different device. As discussed above, in the context of a mobility/relocation use case, the Source-EES (S-EES) is the EES used before mobility/relocation happens, and the Target-EES (T-EES) is the EES used after mobility/relocation has happened. There can be one or more EES instance 216 per EDN 212 (or per data network name (DNN)). There can be multiple EDN instances 212 in the network 210.

In some embodiments, an Edge Configuration Server (ECS) 218 may comprise an application, server, service, daemon, routine, or other executable logic for providing supporting functions for an EEC 206 or EES 216 to discover EES instances 216 providing certain EAS 214. For example, an ECS may comprise a configuration database, a user database, an application database, or other such database for identifying EASs 214 and/or EECs 206 or ACs 204. ECS 218 may be provided by one or more computing devices, including physical or virtual computing devices (e.g. cloud servers) as discussed above. There can be one or more ECS 218 for the network.

In some embodiments, a Notification Management Client (NMC) 208 provides supporting functions for an EEC 206 to create a notification channel (NM-UU) between the NMC 208 and a Notification Management Server (NMS) 220 to receive notifications from the ECS or EES. In some embodiments, each EEC uses only one NMC. The NMC 208 may be an application, service, server, daemon, routine, or other executable logic executed by one or more processors of a UE/WTRU 202 and/or in communication with processors of a UE/WTRU 202. For example, NMC 208 may comprise an application provided by an EAS 214 in some implementations. In other implementations, NMC 208 may comprise a service executed by an application or operating system of the WTRU, such as a listening service or other routine for periodically pulling and/or receiving notifications from a NMS 220. As shown, the NMC 208 may be provided as a service enabler architecture layer (SEAL) service. The NMC 208 may support for notification management functions to EEC 206 and ACs 204, sometimes referred to as vertical application layer (VAL) client(s) over a NM-C reference point.

In some embodiments, a Notification Management Server (NMS) 220 provides supporting functions for an ECS or EES to send notifications to an EEC via a notification channel created between the NMC and the NMS. The NMS 220 may be an application, service, server, daemon, routine, or other executable logic executed by one or more physical computing devices and/or virtual computing devices executed by physical computing devices. There can be one or more NMS 220 for the network. The NMS 220 may communicate with NMC 208 via a NM-UU reference point (e.g. point-to-point interface via network 210 or another network) or via a PUSH server for indirect delivery, and may provide notification management functions to EECs 218, and EES 216 via NM-S reference points (e.g. point-to-point interfaces via network 210 or another network).

3GPP TS 23.558V18.1.0 , “Architecture for enabling Edge Applications,” which is incorporated by reference herein, describes some embodiments of service continuity procedures in the Edge Enabler Layer (EEL) for transferring an application context from a S-EAS to a T-EAS. As discussed above, the context transfer may be triggered for example by UE movement as well as non-mobility events such as for example EAS server maintenance, overload, etc. The purpose of service continuity is to minimize edge service interruption to the ACs 204 executing on the UE 202.

Service continuity for applications requiring context relocation is specified by the EEL in five different application context relocation (ACR) scenarios. Each scenario may include 4 different phases: detection, decision, execution, and post-execution. ACR scenarios may specify different EEL entities (e.g., EEC, EES, EAS) for the detection and decision phases (e.g., a detection entity and a decision-making entity), and different sets of interactions between EEL entities for the execution phase.

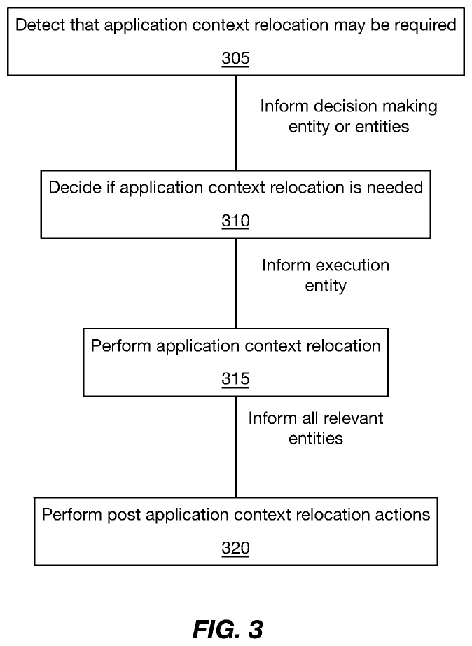

FIG. 3 is a flow chart of an embodiment of a method for application context relocation. In brief overview, the detection entity, which may be executed by or on the UE or WTRU or on an external server or another computing device in various implementations, monitors the UE or WTRU location, movement, or other physical or network characteristics (e.g. noise, latency, congestion, velocity or acceleration, location coordinates, received beacon signal strengths, etc.) and informs the decision-making entity (step 305). The decision-making entity, which may similarly be executed by or on the UE or WTRU or on an external server or another computing device in various implementations, then determines if an ACR is required and commands the execution entity to perform ACR (step 310). The execution entity, which may similarly be executed by or on the UE or WTRU or on an external server or another computing device in various implementations, then runs the ACR procedures defined in the service continuity scenarios to transfer the application context from the S-EAS to the T-EAS (step 315). When ACR execution is complete, ACR cleanup is performed (step 320). For example, a WTRU executing a detection entity (which may comprise an EEC 206) may monitor network or device characteristics. In some implementations, a decision making entity of the WTRU (which may similarly comprise an EEC 206) may determine based on the measurements that ACR is necessary and may communicate with EES 216 and/or ECS 218 to initiate a transfer. Conversely, in some implementations, measurements may be reported by the WTRU's detection entity to a decision making entity on an EES 216, which may determine that ACR is necessary and may communicate with EEC 206 and/or ECS 218.

Various methods may be utilized for EEC authorization, including pre-configuring a token for future EEC pull or push context transfers. In brief overview, in a first aspect, to pre-configure a token for future EEC pull context transfers, in some embodiments, an EEC may perform one or more of the following steps.

First, in some implementations, the EEC (e.g. an EEC 206) may send a request to a server for a token. The request may identify an instance of EEC Context. In some implementations, the request may also indicate a request for Authorization Limits. In some embodiments, the EEC Context may be identified by an EEC Context ID or Session Context which may be identified by a combination of some or all of application client identifiers (ACID), EEC identifiers (EEC ID), user equipment identifiers (UE ID), S-EAS endpoints and/or T-EAS endpoints. In some embodiments, the Authorization Limits may indicate specific T-EES(s) that may be authorized with the token. In some embodiments, the Authorization Limits may indicate that only T-EES(s) of certain types may be authorized with the token. In some embodiments, the Authorization Limits may indicate that only T-EES(s) associated with specific service providers may be authorized with the token. In some embodiments, the Authorization Limits may indicate that only T-EES(s) in certain locations may be authorized with the token. In some embodiments, the Authorization Limits may indicate that only T-EES(s) in certain EDN(s) may be authorized with the token. In various embodiments, any of the above Authorization Limits may indicate which T-EES(s) may not be authorized with the token. The request may also include a requested token validity time. In some embodiments, the token server may be an ECS 218 and/or an EES 216, or may be an application or server executed by an ECS 218 or similar hardware server.

In many implementations, authorization limits may identify characteristics of an EES rather than identifying a specific EES. For example, rather than identifying a particular server, the authorization limits may specify that a server may be authorized if it has an uptime greater than a threshold, or a resource utilization less than a threshold, or is within a threshold number of miles from a geographic location, or has a latency to the EEC or ECS less than a threshold, or has a particular application serving capability (e.g. that the server can host an artificial intelligence/machine learning application, or can provide a web interface to a web application, or can provide remote data storage capabilities, etc.), or has a specified operating system version (indicating that particular patches are up to date, for example), or has other specialized hardware or access to such hardware (e.g. a satellite uplink, or a ray-tracing GPU, etc.). In some such implementations, the group of potential EESs that have characteristics that may meet the authorization limits may be referred to as candidate target EESs or by similar terms. Frequently, not all EESs may meet the requirements, and accordingly, the candidate target EESs may be a subset of the EESs in the system. In many implementations, the authorization limits may be agnostic to any particular EES or may not include an identification of a particular EES, but may only include the required characteristics for authorization or validity of the token.

Second, in some implementations, the EEC 206 may receive a response from the server. In some embodiments, the response may include a token and, in some cases, Authorization Limits that apply to the token. The response may also include a token validity duration.

Third, in some implementations, the EEC 206 may send a message to a first EES (S-EES 216A). In some embodiments, the message may include the token and the Authorization Limits (e.g., if they were included with the token). In some embodiments, the message may also include the token validity duration. The message may be used to control which other EES(s) (T-EES) may receive context information that is associated with the EEC 206. For example, a T-EES may transmit a request for context information to a S-EES in some implementations, and the S-EES may determine, based on the Authorization Limits, whether the T-EES is authorized to receive the context information.

Fourth, in some implementations, the EEC 206 may decide to perform an ACR procedure and select a T-EES (e.g. T-EES 216B). Selecting the T-EES may comprise identifying a T-EES from candidate T-EESs that has characteristics that satisfy the requirements of authorization limits associated with the token. For example, the EEC may select a T-EES having a location within a required area, or a latency below a required threshold, or with the capability of providing a particular application service, etc.

Fifth, in some implementations, the EEC 206 may send an ACR Request to the selected T-EES 216B. In some embodiments, the request may include the token. In such embodiments, the T-EES may use the token to retrieve EEC context information from the S-EES 216A (if the token Authorization Limits do not prevent the T-EES from receiving the context information).

Sixth, in some implementations, the EEC 206 may receive a message from the T-EES 216B (e.g., if the T-EES was not prevented by the token Authorization Limits from receiving the context information). In some embodiments, the message includes an indication that the Authorization Token was used to authorize the context transfer to the T-EES. In some embodiments, the message may trigger the EEC 206 to consider the token invalid and re-initiate this procedure in order to obtain a new token for a future ACR procedure. For example, the T-EES 216B may indicate that it was prevented by the Authorization Limits, or the T-EES 216B may provide an indication that context transfer was authorized, but the token may have expired during the interim. Messages provided by the T-EES 216B may be an ACR Information Notification or any other suitable type and format of notification message.

In another aspect, to preconfigure a token for future EEC push context transfers, an EEC may perform one or more of the following steps:

First, in some implementations, the EEC 206 may send a request to a server for a token. In some embodiments, the request identifies an instance of EEC Context. In some embodiments, the request also indicates a request for Authorization Limits.

In some embodiments, the EEC Context is identified by an EEC Context ID or Session Context which may be identified by a combination of ACID, EEC ID (or UE ID), S-EAS endpoint and T-EAS endpoint. In some embodiments, the Authorization Limits may indicate specific T-EES(s) that may be authorized with the token. In some embodiments, the Authorization Limits may indicate that only T-EES(s) of certain types may be authorized with the token. In some embodiments, the Authorization Limits may indicate that only T-EES(s) associated with specific service providers may be authorized with the token. In some embodiments, the Authorization Limits may indicate that only T-EES(s) in certain locations may be authorized with the token. In some embodiments, the Authorization Limits may indicate that only T-EES(s) in certain EDN(s) may be authorized with the token. In some embodiments, any of the above Authorization Limits may indicate which T-EES(s) may not be authorized with the token. As discussed above, Authorization Limits may refer to required characteristics or characteristics and corresponding thresholds which may be met by some EESs, for which the token correspondingly indicates authorization of context transfer.

In some embodiments, the request may also include a requested token validity time. The token server may be an ECS 218 in many implementations.

Second, in some implementations, the EEC 206 may receive a response from the server. In some embodiments, the response includes a token and Authorization Limits that apply to the token. The response may also include a token validity duration.

Third, in some implementations, the EEC 206 sends a message to a first EES (S-EES 216A). In some embodiments, the message includes the token and the Authorization Limits. The message may also include the token validity duration. The purpose of the message may be to control which other EES(s) (T-EES 216B) may receive context information that is associated with the EEC.

Fourth, in some implementations, the EEC 206 receives a message from the first EES (S-EES 216A). In some embodiments, the message includes an indication that the Authorization Token was used to authorize the context transfer to the T-EES 216B. In some embodiments, the message may include a T-EES identity (for example, the S-EES 216A may select the T-EES to which the context is being transferred from a plurality of potential EES(s) 216). The message may trigger the EEC to consider the token invalid and re-initiate this procedure in order to obtain a new token for a future ACR procedure. In some embodiments, the message may be an ACR Information Notification.

Aspects of these embodiments are discussed in more detail below.

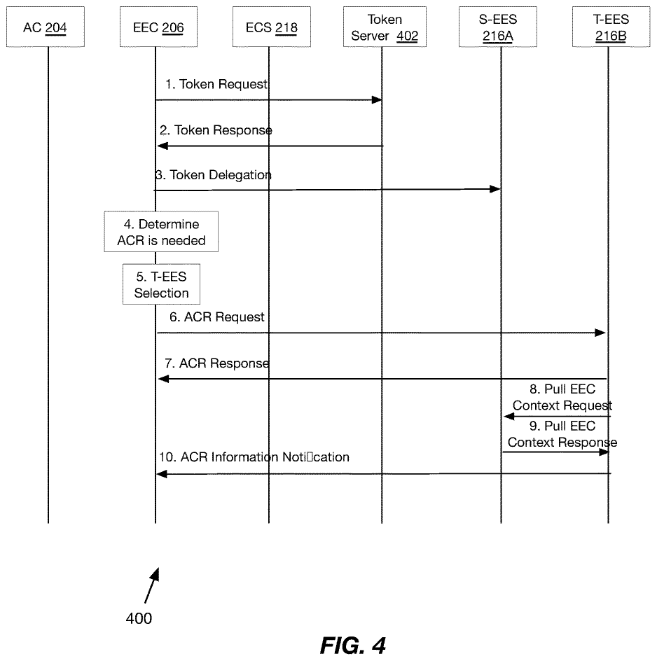

FIG. 4 illustrates an embodiment of a procedure 400 for EEC Authorization of EEC Context transfer in a scenario where an ACR procedure is initiated by the EEC 206 and the procedure requires that EEC Context be pulled from the S-EES 216A to the T-EES 216B. In such embodiments, the EEC 206 may obtain a token before any entity in the EEL determines to initiate an ACR procedure. In some embodiments, the EEC 206 negotiates with the Token Server 402 (which may be provided by an ECS 218) to place limits in which entities can use the token. In some embodiments, the EEC 206 then provides the token to the S-EES 216A. The S-EES 216A later uses the token when authorizing a request from the T-EES 216B to retrieve the EEC's context. Advantageously in these embodiments, the EEC 206 may be able to exercise a degree of control over where its context can be transferred, even if the S-EES 216A is not able to communicate with the EEC at the time when the context transfer needs to take place (e.g. due to changing network conditions, because the EEC has moved out of range of the S-EES, etc.).

In step 1, in some embodiments, the EEC 206 sends a request to a Server 402 to obtain an Authorization Token. The Authorization Token is to be used to authorize the transfer of the EEC's context from a source EES (S-EES 216A) to the T-EES 216B. The request to the server may include the identity of the S-EES 216A. Since no T-EES 216B may have yet been determined or selected, the request may not identify a T-EES or may indicate no T-EES is selected. In some embodiments, the request also identifies the context to the transferred. The context is identified by a EEC Context ID or by a combination of identities which includes the ACID, EEC ID (or UE ID), S-EAS endpoint and T-EAS endpoint. In some embodiments, the session context needs to be identified because multiple ACR procedures for the same EEC (UE), S-EES, and T-EES may take place simultaneously. In some embodiments, the request may also include a requested token validity duration time that indicates to the server that it should consider the token valid only for the indicated time duration. In some embodiments, the request also indicates Requested Authorization Limits. The Requested Authorization Limits may indicate limits on which T-EES may be authorized with the token. The limits may indicate specific T-EES that may be authorized with the token. The limits may indicate that only T-EES of certain types, associated with specific service providers, or in certain locations may be authorized with the token. Alternatively, the limits may indicate which T-EES(s) may not be authorized with the token.

In some embodiments, the server 402 may be the ECS 218. The request may be integrated with the Service Provisioning procedure.

In step 2, in some embodiments, the server 402 responds to the EEC 206 with the Authorization Token. In some embodiments, the response includes a token validity duration that indicates how long the server will consider the token to be valid. In some embodiments, the response also indicates the Authorization Limits that apply to the token. Note that the EEC 206 may choose to request the token after determining to perform an ACR.

In step 3, in some embodiments, the EEC 206 sends a Token Delegation message to the S-EES 216A. In some embodiments, the request includes the Authorization Token, the token validity duration and the Authorization Limits that apply to the token. In these embodiments, the word delegation refers to the EEC 206 delegating the job of Token validation to the S-EES 216A. The S-EES may subsequently perform token validation (e.g. as part of step 9 in transferring the EEC context).

In step 4, in some embodiments, the EEC 206 determines to perform an ACR procedure. For example, the EEC 206 may be triggered to perform an ACR procedure based on detecting a change of UE location. In some embodiments, the EEC 206 may also be triggered to perform the ACR procedure based on a notification request from an ECS 218.

In step 5, in some embodiments, the EEC 206 selects one of the EES(s) to serve as a target EES (T-EES 216B) in the ACR procedure.

In step 6, in some embodiments, the EEC 206 initiates the ACR launching procedure by sending an ACR Request to the T-EES 216B. The request may include the Authorization Token and the identity of the S-EES 216A. In some embodiments, the request also includes information (e.g., EEC Context ID or ACID, EEC ID (or UE ID), S-EAS endpoint and T-EAS endpoint) that will be used by the T-EES 216B to identify the EEC Context that will need to be transferred as part of the ACR procedure. In some embodiments, the T-EES 216B may determine whether an Authorization Token is required to perform the context transfer. The determination of whether the Authorization Token is required may be based on local policies or an indication that was previously received from the EEC 206 (e.g., during a registration procedure).

In step 7, in some embodiments, the T-EES 216B sends an ACR Response message to the EEC 206. If the T-EES 216B determines that the Authorization Token was not included in the ACR Request, that the token was not properly formatted (e.g. is not associated with the identified S-EES 216A), that the token is expired, or the token is not associated with the context that will need to be transferred, then the T-EES 216B may indicate that the request was rejected and include a cause code that identifies the reason for the rejection.

In step 8, in some embodiments, if the Authorization Token was included in the ACR Request, the T-EES 216B may determine that it is authorized to pull the EEC context from the S-EES; if the T-EES is authorized, the T-EES 216B may initiate an EEC Context Pull relocation procedure with the identified S-EES by sending a Pull EEC Context Request to the S-EES 216A. The EEC Context Pull may include the Authorization Token.

In step 9, in some embodiments, the S-EES 216A may validate that the token applies to the context that is requested to be transferred and validates the token (for example, the S-EES 216A may check that the token is the same token that was provided by the EES to the S-EES in step 3, may verify a signature of the token, and/or may transmit the token to the token server 402 for validation or verification). The S-EES 216A may first determine whether the token is valid to authorize the S-EES 216A to transfer the EEC context to the T-EES 216B; if the pull request included an authorization token in step 8, the S-EES may verify if the token received in the Pull EEC context request is valid to authorize the S-EES 216A to transfer the EEC context to the T-EES 216B. The S-EES 216A may send a Pull EEC Context Response message to the T-EES and indicate success or failure. If the failure is due to an invalid token, the S-EES may inform the T-EES that the token is not valid and the S-EES may include a reason for it being invalid (e.g., the token is expired).

In step 10, in some embodiments, the T-EES 216B may send an ACR Information Notification to the EEC 206. In some embodiments, the ACR Information Notification may include an indication of which Authorization Token was used to Authorize the context transfer to the T-EES 216B, as well as whether the token was invalid or valid, and whether the transfer was successful or unsuccessful. This message may trigger the EEC to consider the token invalid and re-initiate this procedure at step 1 in order to obtain a new token for the S-EES for a future ACR procedure. Note that when the procedure is re-initiated, the S-EES may be the EES that is considered the T-EES in this procedure in some implementations (e.g. the procedure may be re-initiated with the T-EES as the new S-EES).

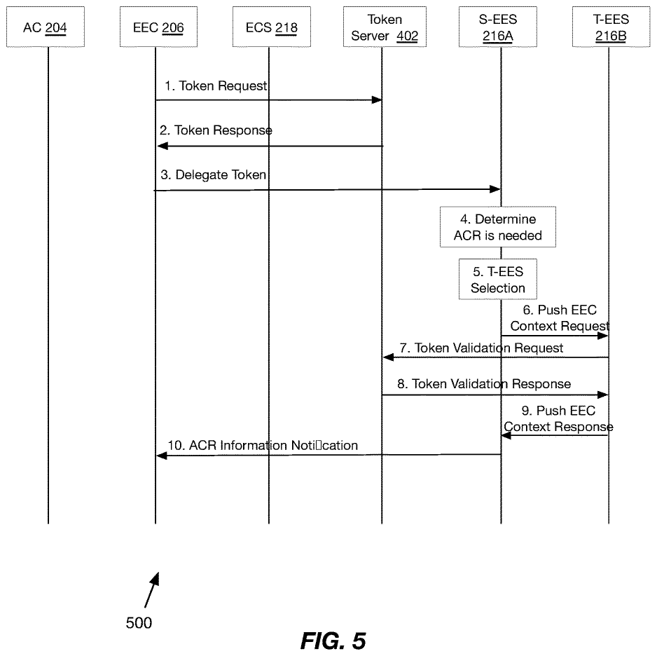

FIG. 5 illustrates an example procedure 500 for EEC Authorization of EEC Context transfer in a scenario where an ACR procedure is not initiated by the EEC 206 and the procedure requires that EEC Context be pushed from the S-EES 216A to the T-EES 216B. In embodiments of this procedure, the EEC 206 may obtain a token before any entity in the EEL determines to initiate an ACR procedure. In some embodiments, the EEC 206 negotiates with the Token Server 402 to place limits in which entities can use the token. The EEC 206 then provides the token to the S-EES 216A. The S-EES 216A later uses the token when transferring context to the T-EES 216B. Additionally, in some implementations, the token may be transferred to the T-EES 216B so the T-EES may validate that it is allowed to accept the EEC context. Advantageously, in some embodiments, the EEC 206 is able to exercise a degree of control over where its context can be transferred, even if the S-EES 216A is not able to communicate with the EEC at the time when the context transfer needs to take place (e.g. due to the EEC being out of range, changing network conditions, etc.).

In step 1, in some embodiments, the EEC 206 sends a request to a Server 402 to obtain an Authorization Token. The token server 402 may be provided by an ECS 218 in some implementations. The Authorization Token may be used to authorize the transfer of the EEC's context from a source EES (S-EES) to the T-EES. In some embodiments, the request to the server includes the identity of the S-EES 216A. Since no T-EES has been determined in these implementations, the request may indicate no T-EES 216B or may be agnostic or blank regarding a T-EES. In some implementations, the request may indicate a plurality of candidate T-EES 216B (e.g. a subset of all T-EES, for example), with the assumption that one of them may be later selected. In some embodiments, the request may identify the context to the transferred. In some embodiments, the session context is identified by an EEC Context ID or by a combination of identifies which includes the ACID, EEC ID (or UE ID), S-EAS endpoint and T-EAS endpoint. In some embodiments, the session context may be identified so that multiple ACR procedures for the same EEC (UE), S-EES, and T-EES may take place simultaneously. In some embodiments, the request may also include a requested token validity duration time that indicates to the server that it should consider the token valid only for the indicated time duration. In some embodiments, the request also indicates Requested Authorization Limits. The Requested Authorization Limits may indicate limits on which T-EES 216B may be authorized with the token. The limits may indicate specific T-EES(s) that may be authorized with the token. The limits may indicate that only T-EES(s) of certain types, associated with specific service providers, or in certain locations may be authorized with the token. Alternatively, the limits may indicate which T-EES(s) may not be authorized with the token. The request may be integrated with the Service Provisioning procedure.

In step 2, in some embodiments, the server 402 may respond to the EEC 206 with the Authorization Token. In some embodiments, the response includes a token and a token validity duration that indicates how long the server will consider the token to be valid. In some embodiments, the response also indicates the Authorization Limits that apply to the token.

In step 3, in some embodiments, the EEC 206 sends a Token Delegation message to the S-EES 216A. In some embodiments, the request includes the Authorization Token, the token validity duration and the Authorization Limits that apply to the token. In some embodiments, the information that is sent in the Token Delegation message may be carried in an EAS Information Provisioning message.

In step 4, in some embodiments, the S-EES 216A determines to perform an ACR procedure. For example, the S-EES 216A may be triggered to perform an ACR procedure based on detecting a change of UE location.

In step 5, in some embodiments, the S-EES 216A selects an EES to serve as a target EES (T-EES 216B) in the ACR procedure. In some embodiments, the S-EES 216A will select a T-EES 216B that can use the Authorization Token (e.g. one that is authorized by the Authorization Limits of the token). In other words, the S-EES 216A may apply a filter to the EES(s) that are considered for T-EES selection (e.g. candidate T-EES(s) such that EES(s) that the token cannot be applied to are not considered.

In step 6, in some embodiments, the S-EES 216A will initiate an EEC Context Push relocation procedure with the identified T-EES 216B by sending a Push EEC Context Request to the T-EES. The EEC Context Push may include the Authorization Token.

In step 7, in some embodiments, the T-EES 216B may send a request to the token server 402 and/or ECS 218 to validate that the token applies to the context that is requested to be transferred and verify that the token is valid. For example, the T-EES may send the token, a hash of the token, an identifier of the token, a signed version of the token or any other type and form of notification.

In step 8, in some embodiments, the server 402 may reply to the T-EES 216B. In some embodiments, the server 402 may inform the T-EES 216B that the token is valid or not valid. If the server 402 informs the T-EES 216B that the token is not valid, it may include a reason for it being invalid (e.g., the token is expired).

In step 9, in some embodiments, the T-EES 216B will send a Push EEC Context Response message to the S-EES 216A and indicate success or failure. If the failure is due to an invalid token, In some embodiments, the T-EES 216B will inform the S-EES 216A that the token is not valid and the T-EES may include a reason for it being invalid (e.g., the token is expired).

In step 10, in some embodiments, the S-EES 216A will send an ACR Information Notification to the EEC 206. In some embodiments, the ACR Information Notification will include the T-EES identity, and an indication of which Authorization Token was used to authorize the context transfer to the T-EES 216B. This message may trigger the EEC 206 to consider the token invalid and re-initiate this procedure at step 1 in order to obtain a new token for the S-EES 216A for a future ACR procedure. Note that when the procedure is re-initiated, in some embodiments, the S-EES may be the EES that is considered the T-EES in this procedure (e.g. transferring context back to the S-EES).

In some embodiments, procedure 500 may start with steps 4 and 5. The S-EES 216A may then execute step 10 to send the T-EES 216B identity to the EEC 206. The EEC 206 may then execute steps 1, 2, and 3 to obtain a token that is associated specifically with the T-EES 216B. The delegate token message may then include the token that is associated specifically with the T-EES 216B. The procedure may then proceed with steps 6, 7, 8, and 9.

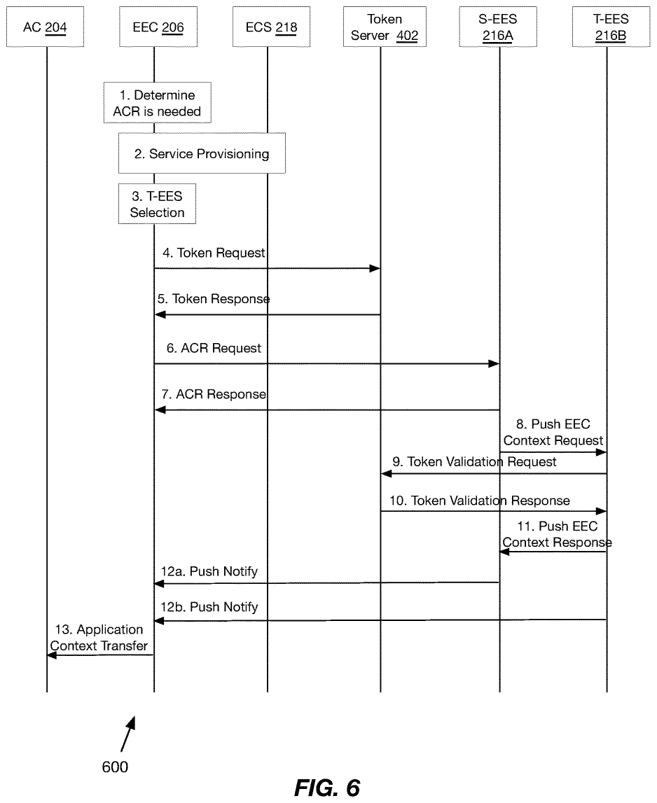

FIG. 6 illustrates an example procedure 600 for EEC Authorization of EEC Context transfer in a scenario where an ACR procedure is initiated by the EEC 206 and the procedure requires that EEC Context be pushed from the S-EES 216A to the T-EES 216B. In some such embodiments, the EEC 206 may determine to perform an ACR procedure, obtain a token, and send the token to the S-EES 216A. The S-EES 216A may use the token to validate if it is allowed to transfer the EEC context to the T-EES 216B. The S-EES 216A may provide the token to the T-EES 216B so that the T-EES 216B can verify that it is permitted to receive the EEC's context.

In step 1, in some embodiments, the EEC 206 determines to perform an ACR procedure. For example, in some embodiments, the EEC 206 may be triggered to perform an ACR procedure based on detecting a change of UE location, network conditions, etc. In other embodiments, the EEC 206 may be triggered to perform the ACR procedure based on a notification request from an ECS 218.

In step 2, in some embodiments, the EEC 206 performs a Service Provisioning procedure with the ECS 218. As part of the Service Provisioning procedure, in some embodiments, the EEC 206 receives information about EES(s) 216 that are available in an EDN. The received information may include the identities of the EES(s) 216. In some implementations, the information may include coverage area(s) of the EES(s) 216, allowing the EEC 206 to select a T-EES 216B based on a location of the UE/WTRU.

In step 3, in some embodiments, the EEC 206 selects one of the EES(s) 216 to serve as a target EES (T-EES 216B) in the ACR procedure. In some embodiments, the EEC 206 also performs T-EAS discovery to determine the identity of a T-EAS 214B. For example, the EEC 206 may broadcast a query to available T-EAS severs, may communicate with an EES 216, may communicate with a management server, etc.

In step 4, in some embodiments, the EEC 206 sends a request to a Server 402 and/or ECS 218 to obtain an Authorization Token. In some embodiments, the Authorization Token may be used to authorize the transfer of the EEC's context from a source EES (S-EES 216A) to the T-EES 218B. In some embodiments, the request to the server 402 may include the identities of the S-EES 216A and the T-EES 218B. In some embodiments, the request also identifies the context to be transferred. In some embodiments, the session context is identified by a EEC Context ID or by a combination of identities which includes the ACID, EEC ID (or UE ID), S-EAS endpoint and T-EAS endpoint. In some embodiments, the session context may be identified so that multiple ACR procedures for the same EEC (UE), S-EES, and T-EES may take place simultaneously. In some embodiments, the request may also include a requested token validity duration time that indicates to the server that it should consider the token valid only for the indicated time duration. The request may be integrated with the Service Provisioning procedure.

In step 5, in some embodiments, the server 400 and/or ECS 218 responds to the EEC 206 with the Authorization Token. In some embodiments, the response includes a token validity duration that indicates how long the server will consider the token to be valid.

In step 6, in some embodiments, the EEC 206 initiates the ACR launching procedure by sending an ACR Request to the S-EES 216A. In some embodiments, the request includes the Authorization Token and the identity of the selected T-EES 216B. In some embodiments, the request also includes information (e.g., EEC Context ID or ACID, EEC ID (or UE ID), S-EAS endpoint and T-EAS endpoint) that will be used by the S-EES 216A to identify the EEC Context that will need to be transferred as part of the ACR procedure. In some embodiments, the S-EES 216A may determine whether an Authorization Token is required to perform the context transfer. The determination of whether the Authorization Token is required may be based on local policies or an indication that was previously received from the EEC 206 (i.e., during a registration procedure).

In step 7, in some embodiments, the S-EES 216A sends an ACR Response message to the EEC 206. If the S-EES determines that the Authorization Token was not included in the ACR Request, that the token was not properly formatted (e.g. is not associated with the identified T-EES 216B), that the token is expired, or the token is not associated with the context that will need to be transferred, then in some embodiments the S-EES 216A may indicate that the request was rejected and include a cause code that identifies the reason for the rejection.

In step 8, in some embodiments, the S-EES 216A may validate that it is authorized to transfer the EEC context to the T-EES 216B by validating the token, the S-EES 216A may interact with the token server (not shown on figure). If authorized, the S-EES 216A may initiate an EEC Context Push relocation procedure with the identified T-EES 216B by sending a Push EEC Context Request to the T-EES 216B. The EEC Context Push may include the Authorization Token.

In step 9, if the token is included, in some embodiments, the T-EES 216B may send a request to the server to validate that the token applies to the context that is transferred and verify that the token is valid.

In step 10, in some embodiments, the server 400 and/or ECS 218 will reply to the T-EES 216B. The server 400 and/or ECS 218 may inform the T-EES 216B that the token is valid or not valid. If the server informs the T-EES 216B that the token is not valid, it may include a reason for it being invalid (e.g., it is expired).

In step 11, in some embodiments, the T-EES 216B will send a Push EEC Context Response message to the S-EES 216A and indicate success or failure. If the failure is due to an invalid token, the T-EES 216B may inform the S-EES 216A that the token is not valid and the T-EES 216B may include a reason for it being invalid (e.g., it is expired, transfer to T-EES instance not allowed).

In step 12a or 12b, in some embodiments, the S-EES 216A or T-EES 216B respectively may notify the EEC 206 if the context push operation was successful or unsuccessful. If the push was unsuccessful, in some embodiments, the S-EES 216A or T-EES 216B may indicate why the operation was unsuccessful. In some embodiments, the T-EES 216B may notify the EEC 206 if the operation was successful and/or the S-EES 216A may notify the EEC 206 if the operation was unsuccessful.

In step 13, in some embodiments, the EEC 206 will send a request to an AC 204 to begin application context transfer. In some embodiments, the EEC 206 may be triggered to send this request by the notification from the S-EES 216A or T-EES 216B.

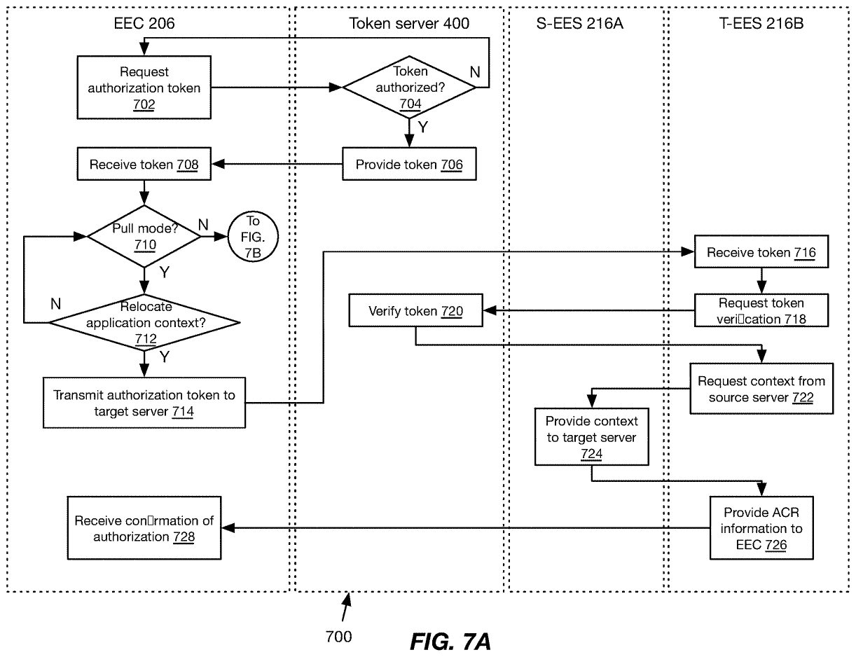

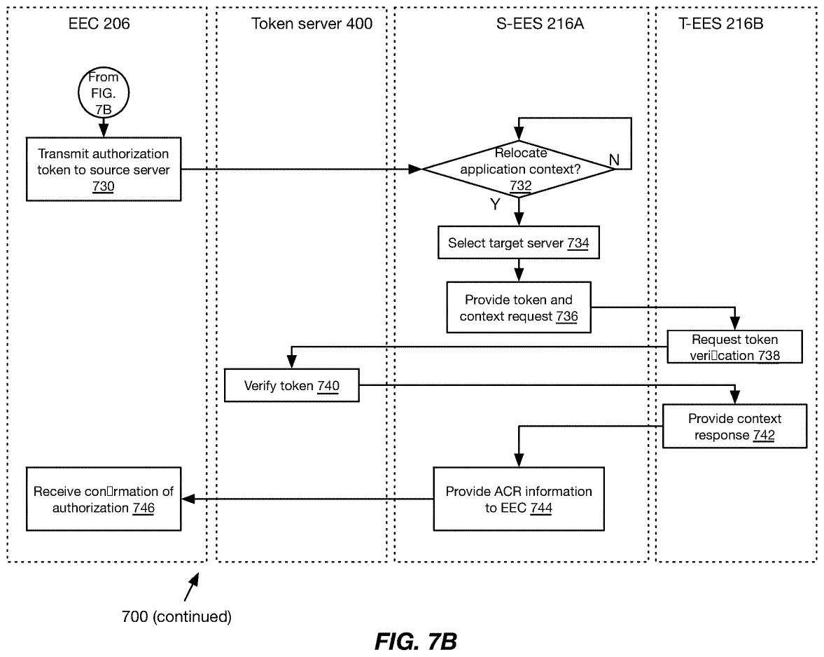

FIGS. 7A and 7B are a flow chart of an embodiment of a method 700 for EEC authorization of EEC context transfer. At 702, in some implementations, an EEC 206 may request an authorization token 702 from a token server 400. The request may be transmitted via any suitable method or communication format, such as via a Uu wireless interface, via a management frame, etc. The request may include an identification of the EEC and/or an associated AC or ACs, a UE ID or WTRU ID, or any other such information. In some implementations, the request may include an identification of a source and/or target EES.

At 704, the token server may, in some implementations, determine whether the EEC is authorized to request a token. For example, the token server may verify a cryptographic signature (e.g. a public key of the EEC), a user ID, or any other such information. If not, the request may be denied, either explicitly or by not returning a token. If so, at 706, the token server 400 may generate a token and provide the token to the EEC. The token may be in any type and format, and may include a cryptographic hash or signature, a UE or WTRU ID, a source and/or target EES identifier, or any other such information. For example, in some implementations, the token may include Authorization Limits, such as an expiration time, location, application type or class, user identifier, T-EES identifier, or any other type and form of limit. At 708, the EEC may receive the token.

As discussed above, in some implementations, the application context may be “pushed” from the source EES to the target EES, while in other implementations, the application context may be “pulled” by the target EES from the source EES. As used herein, pushing and pulling may accordingly indicate which of the EESs initiates the context transfer from the other of the EESs (e.g. pulling by the T-EES or pushing by the S-EES).

If the device is configured for “pull” mode at 710, then at 712, in some embodiments, the EEC 206 may determine whether to relocate an application context. This may be based on any type and form of information or measurements, such as a location of the device, measurements of network characteristics including latency, throughput, bandwidth, and congestion, geographic proximity to an EES, etc.

In some implementations, responsive to determining to relocate the application context, at 714, the EEC 206 may provide the authorization token to a target server (e.g. T-EES 216B). In some implementations, providing the authorization token may comprise selecting, from a plurality of EES(s), a T-EES that is suitable for receiving the application context and providing application services after relocation. The T-EES may be selected based on its location, its network connection or characteristics of a network connection between the EEC and T-EES, etc. For example, the T-EES may be selected based on characteristics (e.g. physical, logical, functional, or other such characteristics) that match, comply, or correspond to authorization limits associated with the token, as discussed above. At 716, the T-EES 216B may receive the token. As discussed above, the token may include Authorization Limits, such as an expiration time, location, application type or class, user identifier, T-EES identifier, or any other type and form of limit.

At 718, the T-EES 216B may attempt to validate or verify the token. Validating the token may comprise checking a hash or cryptographic signature of the token, or transmitting a message to a token server 400 or other authorization server for information to verify the token. For example, in some implementations, the T-EES may provide a user identifier, location, or any other such information to the token server. In some embodiments, the token may be signed with a private key of the token server, and the T-EES may verify the token's provenance via a public key of the token server and verification of the information payload of the token. At 720, the token server may verify the token (e.g. compare the token a user or EEC database, etc.) and/or verify authorization limits of the token (e.g. that the T-EES 216B is authorized to utilize the token for a context transfer, that the token is not expired, that the token is associated with an application provided by the T-EES or an associated EAS, that the characteristics of the T-EES correspond to or comply with authorization limits associated with the token, etc.). The token server may reply to the T-EES with an identification of authorization or an error (or other message indicating invalidity of the token or lack of authorization to use the token).

At 722, if the token is valid, the T-EES may transmit a request for context information of an application client from a S-EES that was providing service to the AC (e.g. a context “pull” request). The request for context information may include the token, and/or may include an identification of authorization or validity of the token, an identification of the AC or EEC or UE/WTRU or a user of the device, or any other type and formation of information. At 724, the S-EES may provide the context to the target server. The context may be in any suitable format, such as a flat file, database, parameter-value pairs, data string or array, bitmap, XML data, compressed data, or any other type and format for providing state or context information of an application client and/or application server.

At 726, the T-EES may provide application context relocation (ACR) information to the EEC 206 to complete the transfer, such as synchronization or handshaking information with the T-EES, state information or other identifiers, or any other type and form of information to enable the EEC and/or AC to resume using an application provided by an EAS. At 728, the EEC 206 may receive this ACR information, and may use it to continue communications of an AC with a corresponding EAS (e.g. continue accessing a web application, etc.).

Turning to FIG. 7B, in implementations using context push requests, at 730, the EEC 206 may transmit an authorization token to an EES-S. As discussed above, this may be performed at some time prior to loss or impairment of communications or prior to physical movement of the UE/WTRU, and accordingly, transmission of the token may not indicate to perform a context transfer.

At 732, the EES-S 216A may determine whether relocation is required. For example, the EES-S 216A may monitor communications with the EEC 206 to determine whether the UE/WTRU has travelled beyond a designated region, whether communications have become impaired or slowed (e.g. due to interference or congestion, etc.). If not, the EES-S may wait (and continue providing application services to the AC). If so, at 734, the EES-S may select a target server. Selection of the T-EES 216B may comprise identifying a T-EES associated with a new location of the WTRU/UE; identifying a T-EES with sufficient bandwidth or processing resources, etc. In some implementations, selection of the T-EES may comprise determining that characteristics of the T-EES match, comply with, or correspond to authorization limits associated with the token. At 736, the EES-S may transmit a context transfer request to the T-EES. The request may comprise the token or an identifier of the token (e.g. a hash or other cryptographic function); an identifier of an application client, EEC, user identifier, UE or WTRU, or any other such information. In some implementations, the request may include Authorization Limits or other such information.

At 738, the T-EES may attempt to validate the token. Validating the token may comprise transmitting the token, a hash of the token, a signed version of the token, or any other type and form of information to the token server 400. In some implementations, validating the token may comprise determining that the token has not expired, and/or that the T-EES is authorized to use the token (if it is valid). At 740, the token server may determine whether the token is valid or not, and may respectively provide either the token information or similar information to the T-EES, or may transmit an error message to the T-EES (e.g. indicating the token is invalid, expired, that the T-EES lacks authority or permission to use the token, etc.).

At 742, if the token is valid and the T-EES is authorized, the T-EES may transmit a response to the initial transfer request. In some implementations, the response may request the context information be provided the T-EES. At 744, responsive to receipt of the response to the context transfer request, the S-EES may provide ACR information to the EEC and/or any other type and form of information (e.g. an identification of the selected target server or T-EES, etc.). At 746, the EEC may receive the confirmation via any suitable means (e.g. a UU interface or other such interference).

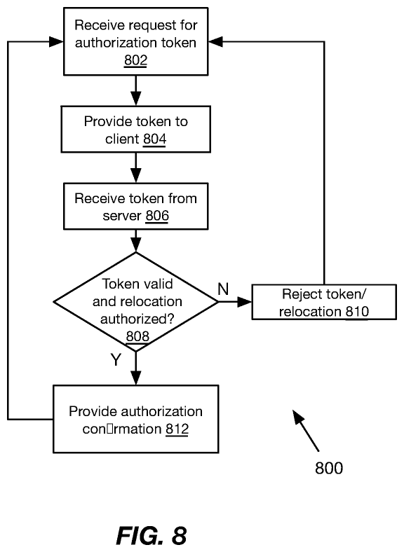

FIG. 8 is a flow chart of an embodiment of a method 802 for EEC authorization of EEC context transfer, from the perspective of a token server or ECS. In some implementations, at 802, the server may receive a request for an authorization token. The request may be received from a UE/WTRU, from an AC or EAC executed by the UE/WTRU or on behalf of the UE/WTRU, etc. The request may comprise an identification of the UE/WTRU, the AC and/or EAC, an S-EES and/or T-EES for context transfer, or any other type and format of information.

At 804, in some implementations, the server may provide the token to the requesting entity (e.g. the UE/WTRU, the AC or EAC executed by the UE/WTRU or on behalf of the UE/WTRU, etc.). The token may comprise one or more Authorization Limits, including an expiration time or date, an identification of applications and/or EES(s) that can provide application service, etc.

Subsequently (e.g. during a context transfer process) at 808, the token server may receive a request to validate the token from an S-EES or T-EES. The request may include any type and form of supporting information, including identifiers of the AC, EAC, or EES(s), a usage time or validity time of the token, user identifiers, etc. In some implementations, the token may be signed via a cryptographic key pair, and the token server may comprise the signed data to the original token data to be sure it is still valid.

If the token is invalid or expired or the T-EES does not have authorization for a context transfer (e.g. does not have characteristics that match or comply with authorization limits associated with the token), at 810, the token server may reject the token and may provide an identification of rejection reason(s) (e.g. expiration of the validity time, restrictions regarding which EES is authorized or eligible to use the token, etc.). If the T-EES does have authorization and/or if the token is valid, then at 812, the token server may provide authorization confirmation to the requesting device or entity. For example, if the T-EES requested to validate the token, the token server may provide an affirmation or other notification of validity of the token or authorization to perform the context transfer to the T-EES. If the S-EES requested to validate the token, then token server may provide an affirmation or other notification of validity of the token or authorization to perform the context transfer to the S-EES.

Accordingly, the present disclosure is directed to embodiments of methods and systems for authorizing the transfer of specific instances of context from a S-EES to a T-EES. Embodiments of these methods and systems may ensure that context information that is associated with the EEC is only sent to a T-EES that is authorized to receive the context.

In a first aspect, the present disclosure is directed to a method for authorization of edge enabler client (EEC) context transfer. The method includes determining, by an edge enabler client (EEC) executed by a wireless transmit receive unit (WTRU), to relocate an application context from a first edge enabler server. The method also includes responsive to the determination, requesting, by the edge enabler client (EEC) from a token server, an authorization token, the request comprising an identification of the application context and an identification of one or more authorization limits, the one or more authorization limits corresponding to characteristics of edge enabler servers required for authorization. The method also includes receiving, by the EEC from the token server, the authorization token for the application context and, in some implementations, an identification of the one or more authorization limits. The method also includes transmitting, by the EEC to the first edge enabler server, the authorization token. The method also includes receiving, by the EEC from one of the first edge enabler server and a second edge enabler server, an indication that the authorization token was used to authorize a context transfer from the first edge enabler server to the second edge enabler server responsive to the second edge enabler server having characteristics matching the one or more authorization limits.

In some implementations, the indication is received from the second edge enabler server, the second edge enabler server transmitting the indication to the EEC responsive to successfully retrieving EEC context information from the first edge enabler server. In a further implementation, the method includes selecting the second edge enabler server, by the EEC, from a plurality of edge enabler servers. In another further implementation, the method includes transmitting an application context relocation request to the second edge enabler server, by the EEC, the application context relocation request comprising the authorization token.

In some implementations, the indication is received from the first edge enabler server, the first edge enabler server transmitting the indication to the EEC responsive to the first edge enabler server successfully pushing EEC context information to the second edge enabler server. In a further implementation, the first edge enabler server selects the second edge enabler server from a plurality of edge enabler servers.

In some implementations, the method includes determining to relocate the application context from the first edge enabler server by monitoring a physical location or movement of the WTRU. In some implementations, the method includes transmitting, by the EEC, a request comprising an identification of one or more authorization limits. In a further implementation, the one or more authorization limits comprise identifications of target edge enabler servers authorized to use the authorization token to receive the relocated application context.

In some implementations, the one or more authorization limits do not identify a specific edge enabler server. In some implementations, the one or more authorization limits comprise an identification of a time period for validity of the authorization token, a location or region, a minimum communication latency, an application capability, or a maximum utilization level.

In another aspect, the present disclosure is directed to a method. The method includes receiving, by an authorization token server, a request from an edge enabler client (EEC) executed by a wireless transmit receive unit (WTRU), for an authorization token, request comprising an identification of an application context associated with a first edge enabler server and an identification of first one or more authorization limits, the one or more authorization limits corresponding to characteristics of edge enabler servers required for authorization. The method also includes providing, by the authorization token server to the EEC, the authorization token. The method also includes subsequently receiving, by the authorization token server from a second edge enabler server, the authorization token. The method also includes determining, by the authorization token server based on characteristics of the second edge enabler server matching the one or more authorization limits, that the authorization token is valid and authorizes a relocation of the application context to the second edge enabler server. The method also includes, responsive to the determination, communicating, by the authorization token server, an authorization for the relocation of the application context to one or more of the EEC, the first edge enabler server, and the second edge enabler server.

In some implementations, the one or more authorization limits do not identify a specific edge enabler server. In some implementations, the one or more authorization limits comprise identifications of specific target edge enabler servers authorized to use the authorization token to receive the relocated application context. In some implementations, the one or more authorization limits comprise a location or region, a minimum communication latency, an application capability, or a maximum utilization level. In some implementations, the one or more authorization limits comprise a time period for validity of the authorization token. In some implementations, the application context comprises WTRU or User Equipment (UE) identity information, location information, application client (AC) profiles, or service session context information.

In another aspect, the present disclosure is directed to a wireless transmit receive unit (WTRU) configured to perform embodiments of the methods discussed above. In another aspect, the present disclosure is directed to a user equipment (UE) configured to perform embodiments of the methods discussed above. In another aspect, the present disclosure is directed to a network device configured to perform embodiments of the methods discussed above. In another aspect, the present disclosure is directed to a computing device configured to perform embodiments of the methods discussed above. In another aspect, the present disclosure is directed to an integrated circuit configured to perform embodiments of the methods discussed above. In another aspect, the present disclosure is directed to a non-transitory computer readable medium comprising instructions which when executed by a processing device cause the processing device to perform embodiments of the methods discussed above. Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A method for authorization of edge enabler client (EEC) context transfer, comprising:
determining, by an edge enabler client (EEC) executed by a wireless transmit receive unit (WTRU), to relocate an application context from a first edge enabler server;
sending a first message, responsive to the determination, by the EEC to a token server, wherein the first message is a request for an authorization token, wherein the first message comprises an identification of the application context and an identification of one or more authorization limits, the one or more authorization limits corresponding to characteristics of edge enabler servers required for authorization;
receiving a second message, by the EEC from the token server, wherein the second message comprises the authorization token for the application context;
sending a third message, by the EEC to the first edge enabler server, wherein the third message comprises the authorization token and an identification of the one or more authorization limits; and
receiving a fourth message, by the EEC from the first edge enabler server, wherein the fourth message comprises an indication that the authorization token was used to authorize a context transfer from the first edge enabler server to a second edge enabler server.

22. The method of claim 21, wherein the fourth message is responsive to the first edge enabler server successfully pushing EEC application context information to the second edge enabler server having characteristics matching the one or more authorization limits.

23. The method of claim 21, wherein determining to relocate the application context from the first edge enabler server further comprises monitoring a physical location or movement of the WTRU.

24. The method of claim 21, wherein the one or more authorization limits do not identify a specific edge enabler server.

25. The method of claim 21, wherein the one or more authorization limits identify specific edge enabler servers for authorization with the token.

26. The method of claim 21, wherein the one or more authorization limits identify certain types of edge enabler servers for authorization with the token.

27. The method of claim 21, wherein the one or more authorization limits identify edge enablers servers in certain locations for authorization with the token.

28. The method of claim 21, wherein the one or more authorization limits identify edge enablers servers that are not authorized with the token.

29. The method of claim 21, wherein the one or more authorization limits comprise an identification of a time period for validity of the authorization token, a location or region, a minimum communication latency, an application capability, or a maximum utilization level.

30. The method of claim 21, wherein the third message comprises a token validity duration.

31. A wireless transmit/receive unit (WTRU) comprising an edge enabler client (EEC), the WTRU comprising:
a receiver;
a transmitter; and
a processor, wherein:
the processor is configured to determine to relocate an application context from a first edge enabler server;
the transmitter is configured to send a first message, responsive to the determination, to a token server, wherein the first message is a request for an authorization token, wherein the first message comprises an identification of the application context and an identification of one or more authorization limits, the one or more authorization limits corresponding to characteristics of edge enabler servers required for authorization;
the receiver is configured to receive a second message, from the token server, the authorization token for the application context;
the transmitter is further configured to send a third message, to the first edge enabler server, wherein the third message comprises the authorization token and an identification of the one or more authorization limits; and
the receiver is further configured to receive a fourth message, from the first edge enabler server, wherein the fourth message comprises an indication that the authorization token was used to authorize a context transfer from the first edge enabler server to a second edge enabler server.

32. The WTRU of claim 31, wherein the fourth message is responsive to the first edge enabler server successfully pushing EEC application context information to the second edge enabler server having characteristics matching the one or more authorization limits.

33. The WTRU of claim 31, wherein the processor is further configured to monitor a physical location or movement of the WTRU.

34. The WTRU of claim 31, wherein the one or more authorization limits do not identify a specific edge enabler server.

35. The WTRU of claim 31, wherein the one or more authorization limits identify specific edge enabler servers for authorization with the token.

36. The WTRU of claim 31, wherein the one or more authorization limits identify certain types of edge enabler servers for authorization with the token.

37. The WTRU of claim 31, wherein the one or more authorization limits identify edge enablers servers in certain locations for authorization with the token.

38. The WTRU of claim 31, wherein the one or more authorization limits identify edge enablers servers that are not authorized with the token.

39. The WTRU of claim 31, wherein the one or more authorization limits comprise an identification of a time period for validity of the authorization token, a location or region, a minimum communication latency, an application capability, or a maximum utilization level.

40. The WTRU of claim 31, wherein the third message comprises a token validity duration.
